(19) United States
(12) Patent Application Publication
(10) Pub. No.: US 2023/0077283 A1
(43) Pub. Date: Mar. 9, 2023

(54) AUTOMATIC MUTE AND UNMUTE FOR AUDIO CONFERENCING

(71) Applicant: QUALCOMM Incorporated, San Diego, CA (US)

(72) Inventors: Uma Mehta, Hyderabad (IN); Vishnu Priyanka Gujjula, Hyderabad (IN); Rajeshwar Kurapaty, Hyderabad (IN); Vikash Garodia, Hyderabad (IN); Malathi Gottam, Guntur (IN)

(21) Appl. No.: 17/468,177

(22) Filed: Sep. 7, 2021

(51) Int. Cl. H04M 3/56; G10L 17/18

(52) U.S. Cl. CPC H04M 3/568; G10L 17/18

(57) ABSTRACT

Techniques for controlling an audio conference include receiving audio data from a participant in the audio conference, analyzing the audio data to determine one or more of a speaker of the audio data or a context of the audio data to produce an analysis of the audio data, and controlling a microphone or adjusting the audio data of the participant based on the analysis of the audio data. The microphone may be muted based on a determination that the speaker is not the participant or the content of the audio is outside of the context of the audio conference.

### TECHNICAL FIELD

This disclosure relates to audio conference management.

### BACKGROUND

Video and audio conferencing is used for both personal and business use. Video and audio conference applications provide a useful tool for meetings between multiple participants at two or more remote locations. Conducting efficient meetings using such conferencing can be difficult in some scenarios. For example, video and audio conferencing applications may support a large number of users for a given meeting. Conferences having a large number of participants can become difficult to manage, as it can be unclear when certain participants have stopped speaking, many participants may speak at once, and background noise can become bothersome if a participant's microphone remains unmuted.

### SUMMARY

This disclosure describes techniques for the automatic muting and/or unmuting of a microphone and/or audio data of a participant in an audio conference. During audio conferences and virtual meetings, several scenarios may arise where unwanted audio is broadcast to all participants of the audio conference. Such scenarios may include a participant speaking out of context, background noise, and voices of other local people not in the conference being picked up by the microphone of the participant. Such unwanted audio may result in inconvenience to the participants in the conference and may also make the speaker uncomfortable.

In one example, this disclosure describes techniques for automatically muting the microphone and/or audio data of a participant of an audio conference. A device on which the audio conference is running may be configured to analyze the audio data captured by the microphone of a participant and determine if the audio data is representative of the voice of the participant and/or determine if the content of the audio data is in the context of the meeting. The device may classify the audio data using one or more artificial intelligence techniques, such as machine learning techniques or neural networks. If the audio data is classified as not matching the voice of the participant, the device may automatically mute the microphone and/or audio data of the participant. Similarly, if the content of the audio data is classified as not matching the context of the audio conference (e.g., includes grammar not related to the topic of the audio conference), the device may automatically mute the microphone and/or audio data of the participant.

In other examples, this disclosure also describes techniques for the automatic unmuting of a microphone and/or audio data. In some instances a participant may have a muted microphone or audio data, but may begin speaking without first unmuting the microphone or audio data. The device on which the audio conference is running may be configured to analyze the audio data captured by the microphone of a participant and determine if the audio data is both representative of the voice of the participant and determine that the content of the audio data is in the context of the meeting. If so, the device may automatically unmute the microphone or audio data of the participant. The automatic muting and unmuting of microphones and/or audio data according to the techniques of this disclosure may limit the amount of unwanted audio in an audio conference and allow such audio conferences to operate more efficiently. Further, the automatic unmuting features of this disclosure may avoid missing participant remarks or the need to repeat remarks.

In one example, this disclosure describes an apparatus configured to control an audio conference, the apparatus comprising a memory configured to receive audio data from a participant in the audio conference, and one or more processor in communication with the memory. The one or more processors are configured to analyze the audio data to determine one or more of a speaker of the audio data or a context of the audio data to produce an analysis of the audio data, and control a microphone or adjust the audio data of the participant based on the analysis of the audio data.

In another example, this disclosure describes a method for controlling an audio conference, the method comprising receiving audio data from a participant in the audio conference, analyzing the audio data to determine one or more of a speaker of the audio data or a context of the audio data to produce an analysis of the audio data, and controlling a microphone or adjusting the audio data of the participant based on the analysis of the audio data.

In another example, this disclosure describes a non-transitory computer-readable storage medium storing instructions that, when executed, cause one or more processors to receive audio data from a participant in an audio conference, analyze the audio data to determine one or more of a speaker of the audio data or a context of the audio data to produce an analysis of the audio data, and control a microphone or adjust the audio data of the participant based on the analysis of the audio data.

In another example, this disclosure describes an apparatus configured to control an audio conference, the apparatus comprising means for receiving audio data from a participant in the audio conference, means for analyzing the audio data to determine one or more of a speaker of the audio data or a context of the audio data to produce an analysis of the audio data, and means for controlling a microphone or adjusting the audio data of the participant based on the analysis of the audio data.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 is a block diagram illustrating a video telephony (VT) session between a first device and a second device, consistent with techniques of this disclosure.

FIG. 2 is a conceptual diagram illustrating techniques for automatically muting a microphone and/or audio data.

FIG. 3 is a conceptual diagram illustrating techniques for automatically unmuting a microphone and/or audio data.

FIG. 4 is a block diagram illustrating a device of FIG. 1 in more detail.

FIG. 5 is a flowchart illustrating an example technique for muting and unmuting a microphone and/or audio data.

FIG. 6 is a flowchart illustrating another example technique for muting and unmuting a microphone and/or audio data.

### DETAILED DESCRIPTION

This disclosure describes techniques for the automatic muting and/or unmuting of a microphone or audio data of a participant in an audio conference. In one example, this disclosure describes techniques for automatically muting the microphone or audio data of a participant of an audio conference. A device on which the audio conference is running may be configured to analyze the audio data captured by the microphone of a participant and determine if the audio data is representative of the voice of the participant and/or determine if the content of the audio data is in the context of the meeting. The device may classify the audio data using one or more artificial intelligence or machine learning techniques, such as a neural network. If the audio data is classified as not matching the voice of the participant, the device may automatically mute the microphone or audio data of the participant. Similarly, if the content of the audio data is classified as not matching the context of the audio conference (e.g., includes grammar not related to the topic of the audio conference), the device may automatically mute the microphone or audio data of the participant.

In other examples, this disclosure also describes techniques for the automatic unmuting of a microphone or audio data. In some instances a participant may have a muted microphone or audio data, but may begin speaking without first unmuting the microphone or audio data. The device on which the audio conference is running may be configured to analyze the audio data captured by the microphone of a participant and determine if the audio data is both representative of the voice of the participant and determine that the content of the audio data is in the context of the meeting. If so, the device may automatically unmute the microphone or audio data of the participant. The automatic muting and unmuting of microphones or audio data according to the techniques of this disclosure may limit the amount of unwanted audio in an audio conference and allow such audio conferences to operate more efficiently.

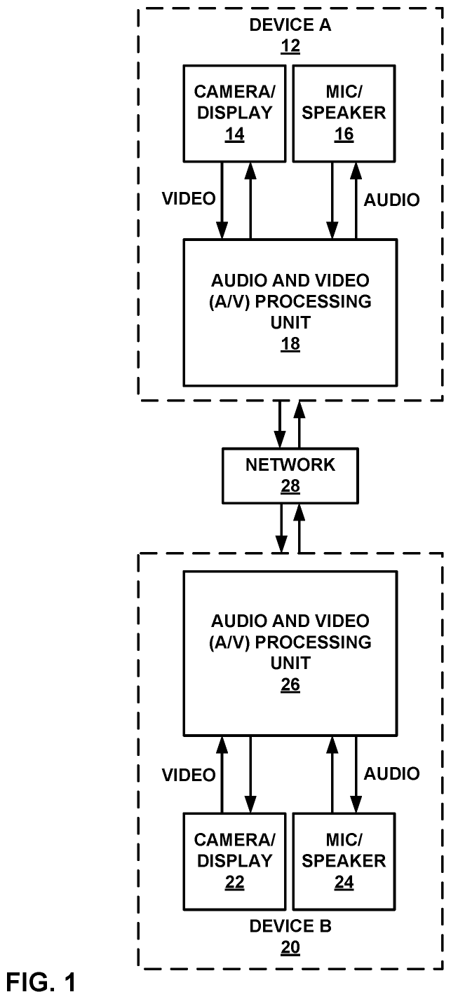

FIG. 1 is a block diagram illustrating an audio conference between a first device and a second device, consistent with techniques of this disclosure. In some examples, the audio conference depicted in FIG. 1 may be a video conference. FIG. 1 depicts two devices participating in the audio conferencing. However, the techniques of this disclosure are applicable for use with any number of devices. First device 12 (Device A) includes a camera and display unit 14, a microphone and speaker unit 16, and an audio and video (AN) processing unit 18. Second device 20 (Device B) includes a camera and display unit 22, a microphone and speaker unit 24, and an audio and video (AN) processing unit 26. First device 12 communicates with second device 20 via network 28.

In the example of FIG. 1, first device 12 may be configured as a smartphone, tablet computer, laptop computer, desktop computer, Wi-Fi enabled television, video conferencing device, or any other device capable of transmitting audio and/or video data. Likewise, second device 20 may be configured as a smartphone, tablet computer, laptop computer, desktop computer, Wi-Fi enabled television, video conferencing device, or any other device capable of receiving audio and/or video data and receiving user input data.

Camera and display unit 14 and camera and display unit 22 may each include a camera for capturing still or video images and a display for presenting video data to a user of first device 12 or second device 20. The display may comprise any of a variety of video output devices such as a liquid crystal display (LCD), a plasma display, a light emitting diode (LED) display, an organic light emitting diode (OLED) display, or another type of display device. In these or other examples, the display device may be an emissive display or a transmissive display.

Microphone and speaker unit 16 and microphone and speaker unit 24 may each include a microphone for capturing sound and a speaker for presenting sound to a user of first device 12 or second device 20. The speaker may comprise any of a variety of audio output devices such as headphones, a single-speaker system, a multi-speaker system, or a surround sound system.

A/V processing unit 18 and A/V processing unit 26 may include a number of units responsible for processing audio and/or video data. Each of A/V processing unit 18 and A/V processing unit 26 may be implemented as one or more microprocessors, digital signal processors (DSPs), application specific integrated circuits (ASICs), field programmable gate arrays (FPGAs), discrete logic, hardware, or any combinations thereof, and may be configured to execute software and/or firmware. Each of A/V processing unit 18 and A/V processing unit 26 may include one or more video encoders or video decoders, either of which may be integrated as part of a combined encoder/decoder (CODEC).

Network 28 generally represents any suitable communication medium, or collection of different communication media, for transmitting audio and/or video data from first device 12 to second device 20. Network 28 may comprise any wireless or wired communication medium, such as a radio frequency (RF) spectrum or one or more physical transmission lines, or any combination of wireless and wired media, WiFi, satellite, coax cable, power line, or any combination thereof). In some examples, network 28 may form part of a packet-based network, such as a local area network, a wide-area network, or a global network such as the Internet. Hence, first device 12 and second device 20 may communicate over a communication channel using a communications protocol, such as a standard from the IEEE 802.11 family of standards.

The example of FIG. 1 generally illustrates a two-way audio conference session over network 28. For example, first device 12 may be a local device responsible for capturing audio and/or video using camera and display unit 14 and microphone and speaker unit 16. A/V processing unit 18 may encode or otherwise compress the audio and/or video data. A/V processing unit 18 also packetize the data for transmission over PS network 28. At second device 20, A/V processing unit 26 may demodulate, de-jitter, decode, A/V sync, and/or post-process received packets. A/V processing unit 26 may then send the processed data to camera and display unit 22 and/or microphone and speaker unit 24 for playback to a user of second device 20.

According to aspects of this disclosure, as will be explained in more detail below, first device 12 may be configured to receive audio data (e.g., from microphone 16) from a participant in an audio conference. First device 12 may be further configured to analyze the audio data to determine one or more of a speaker of the audio data or a context of the audio data to produce an analysis of the audio data, and control microphone 16 and/or audio data of the participant based on the analysis of the audio data. For example, device 12 may automatically mute microphone 16 if the analysis of the audio data determines that the audio data does not match the voice of the participant and/or the content of the audio data is out of context with the meeting (e.g., the content of the audio data uses grammar not associated with the context of the audio conference). Similarly, first device 12 may be configured to automatically unmute microphone 16 in the case that the analysis of the audio indicates that the audio data matches the voice of the participant and/or matches the context of the audio conference.

Techniques of this disclosure may refer to controlling (e.g., muting and/or unmuting) a microphone. In some examples, muting a microphone may refer to disabling microphone 16 such that microphone 16 no longer captures and generates audio data. In other examples, muting a microphone may refer to muting, silencing, nulling, lowering the volume (e.g., to zero), and/or removing (e.g., from an audio stream) audio data generated by a particular microphone such that the audio data is no longer audible to other participants of the audio conference. In this example, the “muted” microphone is still operational and may continue to capture and generate audio data that may be used for other purposes, such as continued analysis to determine if and when to unmute the microphone and/or audio data. In this context, controlling the microphone may also be referred to as adjusting audio data, where adjusting the audio data may include unmuting or unmuting the audio data.

Techniques of this disclosure will be described with reference to first device 12 and AN processing unit 18. However, it should be understood that device 20 or any another device participating in an audio conference may apply the techniques of the disclosure. Furthermore, in some examples, the techniques of this disclosure may occur on a single, centralized device that is configured to control the microphones of one or more remote devices.

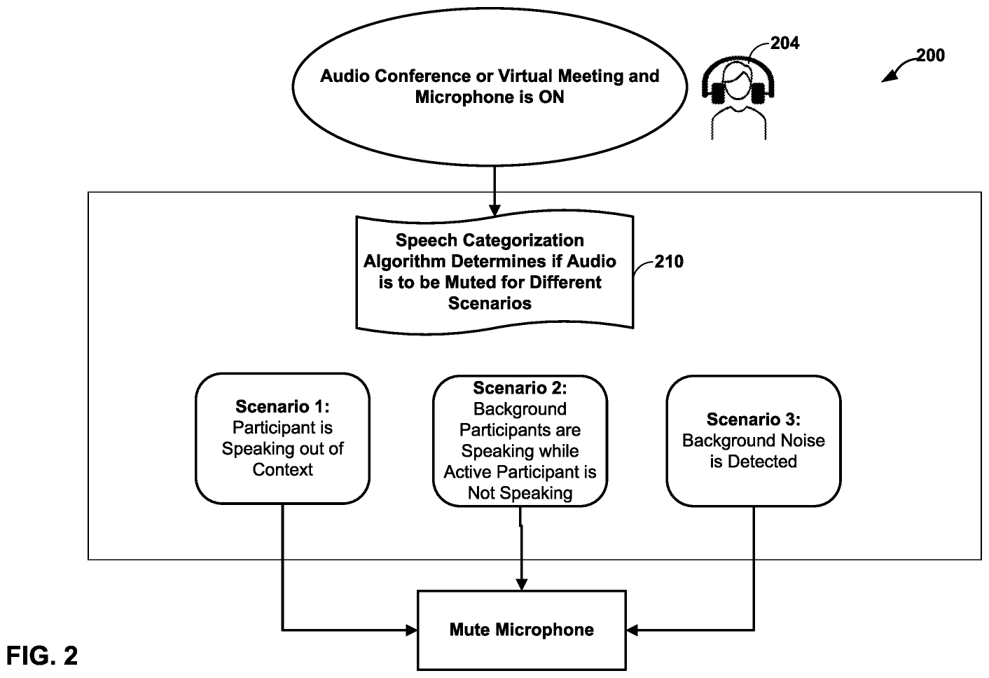

FIG. 2 is a conceptual diagram illustrating techniques for automatically muting a microphone and/or audio data. FIG. 2 illustrates an audio conference 200 (or any type of virtual meeting) having a participant 204 with a microphone that is on (e.g., microphone 16 of FIG. 1). In this example, first device 12 may be configured to execute a speech categorization algorithm 210 that is configured to determine if the audio data received from the microphone of participant 204 is to be muted for different scenarios.

In scenario 1, speech categorization algorithm 210 may be configured to determine that the content of the audio data is out of context with the context of audio conference 200. For example, participant 204 may be using words, phrases, or other grammar that is in a different context from the context of the meeting. In context audio data may also be audio data that includes words that exceed a predetermined hit rate relative to a list of in-context words. In scenario 2, the audio data includes background participants, other than participant 204, that are speaking while participant 204 (e.g., the active participant) is not speaking. In scenario 3, the audio data includes background noise while participant 204 has an active microphone. In each of the scenarios, first device 12 may be configured to automatically mute the microphone of participant 204.

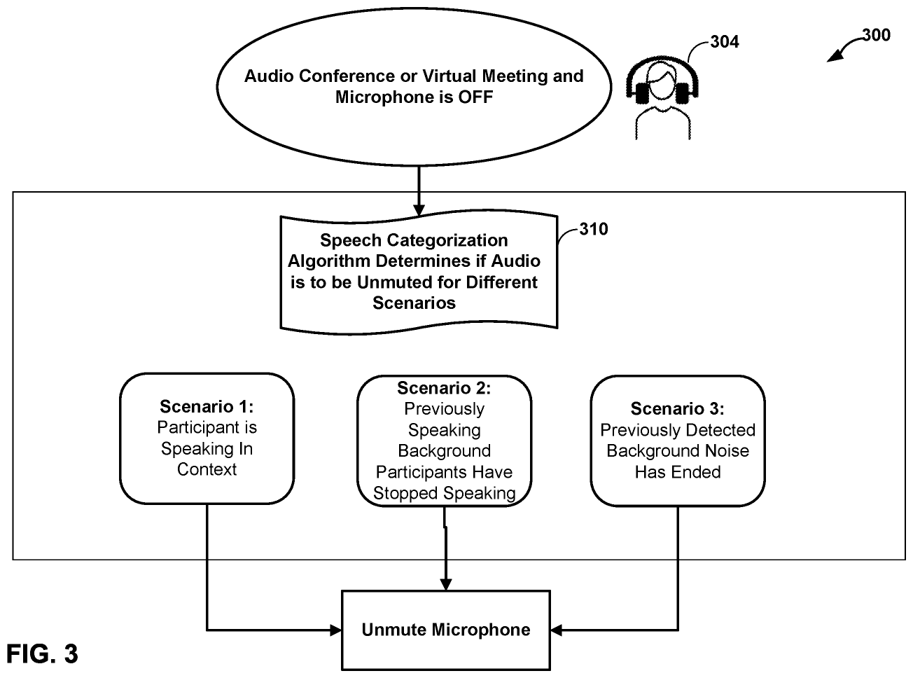

FIG. 3 is a conceptual diagram illustrating techniques for automatically unmuting a microphone. Similar to FIG. 2, FIG. 3 illustrates an audio conference 300 (or any type of virtual meeting) having a participant 304 with a microphone that is off (e.g., microphone 16 of FIG. 1). In this context, a microphone being “off” indicates that audio data captured by the microphone is not broadcast or made to be audible to other participants in the audio conference, but that the microphone continues to capture audio data for analysis by speech categorization algorithm 310. In this example, first device 12 may be configured to execute a speech categorization algorithm 310 that is configured to determine if the audio data received from the microphone of participant 204 is to be unmuted for different scenarios.

In scenario 1, speech categorization algorithm 310 may be configured to determine that the content of the audio data is in context with the context of audio conference 200. For example, participant 204 may be using words, phrases, or other grammar that are in the same context as the context of the meeting. In scenario 2, the audio data that previously included background participants that were speaking no longer includes audio from background participants. That is, previously speaking background participants have stopped speaking and the correct participant is now speaking. In scenario 3, the audio data that previously included background noise is now free of background noise. In each of the scenarios, first device 12 may be configured to automatically unmute the microphone of participant 304.

The scenarios in FIG. 2 and FIG. 3 are meant to be examples of scenarios where microphones and/or audio data may be muted or unmuted and are not meant to be exhaustive. In general, first device 12 may be configured to classify the audio data relative to the voice of an active participant (e.g., speaker identification) to determine if the audio data is representative of the voice of the speaker. The speaker identification techniques of this disclosure may cause first device 12 to mute a microphone if the audio data is representative of a speaker other than the active participant and/or if the audio data is representative of noise (e.g., noise above a threshold decibel level). First device 12 may be further configured to classify the audio data relative to an expected context of the audio conference to determine if the content of the audio data is out of context. In this disclosure, the context of an audio conference may include an expected set of words, phrases, terms, grammar, language, or other data that may be indicative of the topic and/or context of the audio conference.

In one example of the disclosure, speech categorization algorithm 210 and 310 may be implemented using one or more artificial intelligence and/or machine learning algorithms. Example artificial intelligence and/or machine learning algorithms may include deep learning systems, neural networks, and other type of predictive analytics systems, including the use of natural language processing.

Artificial neural networks (ANNs), including deep neural networks (DNNs), have shown great promise as classification tools. A DNN includes an input layer, an output layer, and one or more hidden layers between the input layer and the output layer. ANNs and DNNs may also include one or more other types of layers, such as pooling layers.

Each layer may include a set of artificial neurons, which are frequently referred to simply as “neurons.” Each neuron in the input layer receives an input value from an input vector. Outputs of the neurons in the input layer are provided as inputs to a next layer in the ANN. Each neuron of a layer after the input layer may apply a propagation function to the output of one or more neurons of the previous layer to generate an input value to the neuron. The neuron may then apply an activation function to the input to compute an activation value. The neuron may then apply an output function to the activation value to generate an output value for the neuron. An output vector of the ANN includes the output values of the output layer of the ANN.

In examples of this disclosure, the output values of the ANN may include one or more classifications related to speaker identification (e.g., a speaker classification) and one or more classification related to the context of the audio conference (e.g., a context classification). As described above, speech categorization algorithms 210 and 310 may be configured to classify audio data as either belonging to an active participant or not belonging to the active participant. For example, the audio data may be representative of another person's voice or may be representative of a noise. In addition, speech categorization algorithms 210 and 310 may be configured to classify the content of audio data as either in context or out of context with an audio conference. First device 12 may be configured to train a neural network executing speech categorization algorithms 210 and 310 using one or more training datasets. In one example, the training dataset may include an expected set of words, phrases, terms, grammar, language, or other data that may be indicative of the topic and/or context of the audio conference. In other examples, the training dataset may include a registered version of a participant's voice.

For each respective training dataset, a training input vector of the respective training dataset comprises a value for each element of the plurality of input elements. For each respective training dataset, the target output vector of the respective training dataset comprises a value for each element of the plurality of output elements. In this example, first device 12 may use the plurality of training datasets to train the neural network to perform both speaker classification and context classification.

In this example, the computing system may obtain a current input vector that corresponds to audio data received from a participant's microphone (e.g., microphone 16 of FIG. 1). First device 12 may apply the DNN to the current input vector to generate a current output vector. First device 12 may then determine, based on the current output vector, a speaker classification and/or context classification of the received audio data. First device 12 may then control a microphone based on the output classification. In general, first device 12 may be configured to receive audio data from a participant in the audio conference, analyze the audio data to determine one or more of a speaker of the audio data or a context of the audio data (e.g., using a neural network) to produce an analysis of the audio data, and control a microphone and/or adjust the audio data of the participant based on the analysis of the audio data.

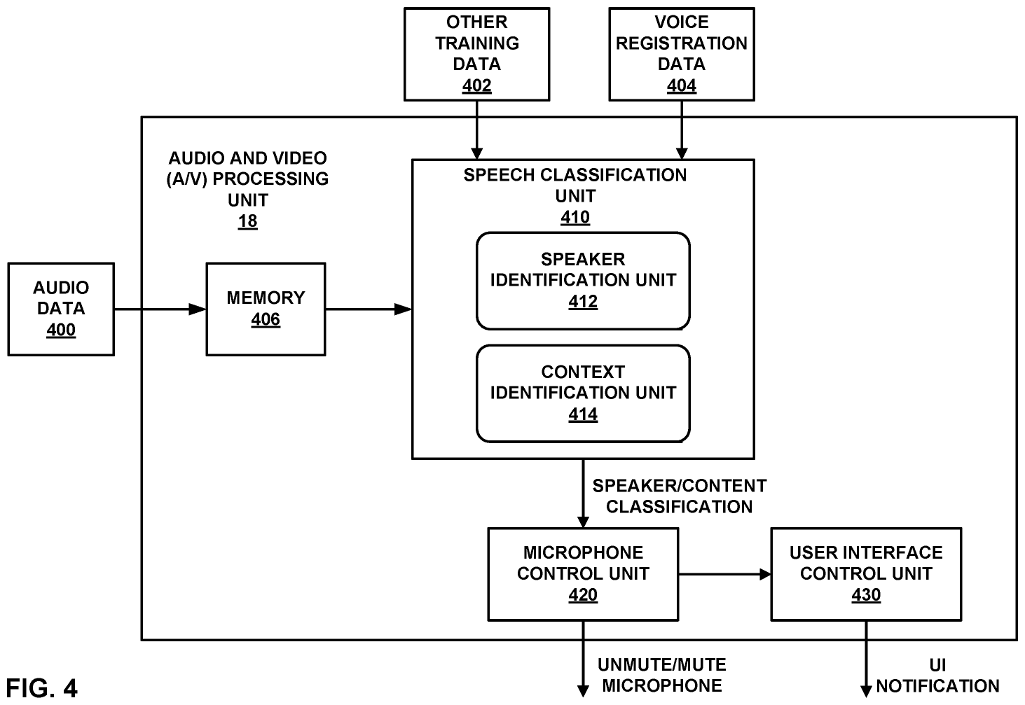

FIG. 4 is a block diagram illustrating a device of FIG. 1 in more detail. In particular, FIG. 4 shows one example implementation of A/V processing unit 18. A/V processing unit 18 may be configured to receive audio data 400 (e.g., from microphone 16 of FIG. 1). A/V processing unit 18 may store the audio data in memory 406. Speech classification unit 410 may be configured to analyze the audio data stored in memory 406. In some examples, speech classification unit 410 may be configured to use one or more of the artificial intelligence and/or machine learning techniques described above. For example, speech classification unit 410 may be configured to implement a neural network to perform the speech categorization algorithms described above with reference to FIG. 2 and FIG. 3. In some examples, A/V processing unit 18 may not be local to the device having the microphone, but may be a remotely located cloud device.

In the example of FIG. 4, speech classification unit 410 includes both a speaker identification unit 412 and a context identification unit 414. Speaker identification unit 412 may be configured to perform the speaker classification described above. Context identification unit 414 may be configured to perform the context classification described. FIG. 4 shows speaker identification unit 412 and context identification unit 414 as separate units executing separate neural networks. In other examples, speaker identification unit 412 and context identification unit 414 may be combined in a single neural network having multiple outputs.

Speech classification unit 410 may be configured to train a neural network executed by speaker identification unit 412 using voice registration data 404. Voice registration data 404 may be a sample of audio data of the voice of a particular participant of an audio conference and/or a user of first device 12. Speaker identification unit 412 may be configured to analyze audio data 400 to determine whether the audio data is representative of the registered participant's voice. For example, speaker identification unit 412 may classify audio data 400 relative to voice registration data 404 to determine a speaker classification. In one example, the speaker classification may indicate whether or not audio data is representative of the participant's voice.

Speech classification unit 410 may send the speaker classification to microphone control unit 420. Microphone control unit 420 may be configured to determine if audio data 400 is representative of the voice of the participant based on the speaker classification. Microphone control unit 420 may be configured to mute the microphone of the participant based on the determination that the audio data is not representative of the voice of the participant. In other examples, microphone control unit 420 may be configured to mute the audio data of the participant based on the determination that the audio data is not representative of the voice of the participant. Microphone control unit 420 may be configured not mute the microphone and/or audio data of the participant based on the determination that the audio data is representative of the voice of the participant. Microphone control unit 420 may inform user interface control unit 430 if the microphone/audio data is muted. If so, user interface control unit may send a UI notification to the user. The UI notification may be visual, audio, and/or haptic notifications. In some example, participant may be able to, through interaction with the user interface, override the automatic mute/unmute control.

Speech classification unit 410 may further be configured to train a neural network executed by context identification unit 414 using other training data 402. Other training data 402 may be an expected set of words, phrases, terms, grammar, language, or other data that may be indicative of the topic and/or context of the audio conference. Context identification unit 414 may be configured to analyze audio data 400 to determine whether the content of the audio data is representative of the context of the audio conference. In this regard, the content of the audio data may be the actual words, phrases, terms, language, etc. contained within audio data 400. In one example, context identification unit 414 may use natural language processing techniques to determine the content of audio data 400. Context identification unit 414 may classify audio data 400 relative to other training data 402 to determine a context classification. In one example, the context classification may indicate whether or not audio data is representative of the context of the audio conference.

Speech classification unit 410 may send the context classification to microphone control unit 420. Microphone control unit 420 may be configured to determine if audio data 400 is representative of a context of the audio conference based on the context classification. Microphone control unit 420 may be configured to mute the microphone and/or audio data of the participant based on the determination that the audio data is not representative of the context of the audio conference. Microphone control unit 420 may be configured to not mute the microphone and/or audio data of the participant based on the determination that the audio data is representative of the context of the audio conference. Microphone control unit 420 may inform user interface control unit 430 if the microphone is muted. If so, user interface control unit may send a UI notification to the user. The UI notification may be visual, audio, and/or haptic notifications.

In some examples, speech classification unit 410 may be configured to receive audio data from one or more participants of an audio conference to gather the other training data 402. Speech classification unit 410 may then periodically retrain the neural network executed by context identification unit 414 based on updated data. In this way, the precision of context classifications produced by context identification unit 414 may be improved.

In addition to automatically muting microphones or audio data, this disclosure also describes features where A/V processing unit 18 may be configured to automatically unmute the audio data from a previously muted microphone. In this example, as discussed above, the previously “muted” microphone continues to be operational, and the audio data captured by the muted microphone is silenced for other participants in the audio conference. In one example, microphone control unit 420 may be configured to determine that the audio data of the participant is muted, and unmute the audio data of the participant based on a determination that audio data 400 is representative of the voice of the participant and/or based on a determination that audio data 400 is representative of the context of the audio conference.

In one example of the disclosure, the use of the speech classification unit 410 and automatic mute and unmute features of this disclosure may be configured as a user selectable feature that may be turned on or off.

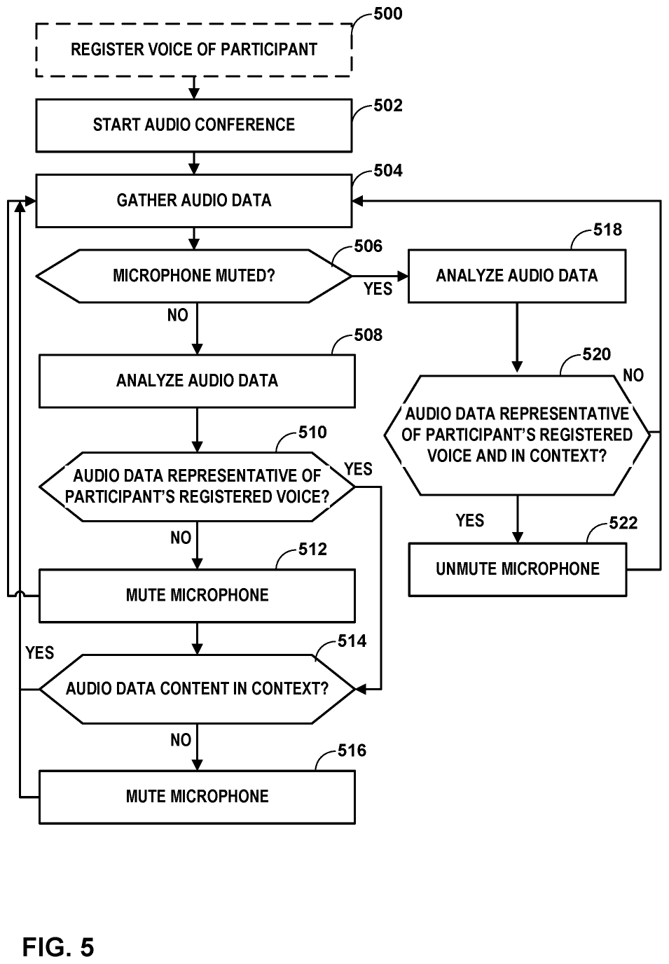

FIG. 5 is a flowchart illustrating an example technique for muting and unmuting a microphone. As discussed above, unmuting and muting microphones may also generally refer to adjusting the audio data such that the audio data is muted or unmuted while the microphone remains operational (e.g., still capturing and producing the audio data when muted). The techniques of FIG. 5 may be performed by one or more structural components of device 12, including A/V processing unit 18. In the example of FIG. 5, speaker classification is performed before context classification. In other examples, this order may be reversed.

Initially, A/V processing unit 18 may optionally register a voice of a participant of an audio conference (500). As discussed above, A/V processing unit 18 may use the registered voice as a training dataset for a neural network. A/V processing unit 18 may be configured to start an audio conference (502) and gather audio data (504) from a microphone of a participant.

A/V processing unit 18 may then determine if the microphone is muted (506). If no at 506, A/V processing unit 18 will then be configured to analyze the audio data (508). A/V processing unit 18 may analyze the audio data using the artificial intelligence techniques described above. A/V processing unit 18 may then determine if the audio data is representative of the participant's registered voice (510). If no at 510, A/V processing unit 18 may then mute the microphone (512) and return to gathering audio data (504).

If yes at 510, A/V processing unit 18 may then determine if the audio data content is in context (514). If no at 514, A/V processing unit 18 may mute the microphone (516) and return to gathering audio data (504). If yes at 514, A/V processing unit 18 may return to gathering audio data (504).

Returning to 506, if the microphone is currently muted, A/V processing unit 18 may still be configured to analyze audio data (518). In this branch, A/V processing unit 18 may determine if the audio data is both representative of the participant's registered voice and is in context with the audio conference (520). If yes at 520, A/V processing unit 18 may unmute the microphone (522) and then return to gathering audio data (504). If no at 520, A/V processing unit 18 may return to gathering audio data (504).

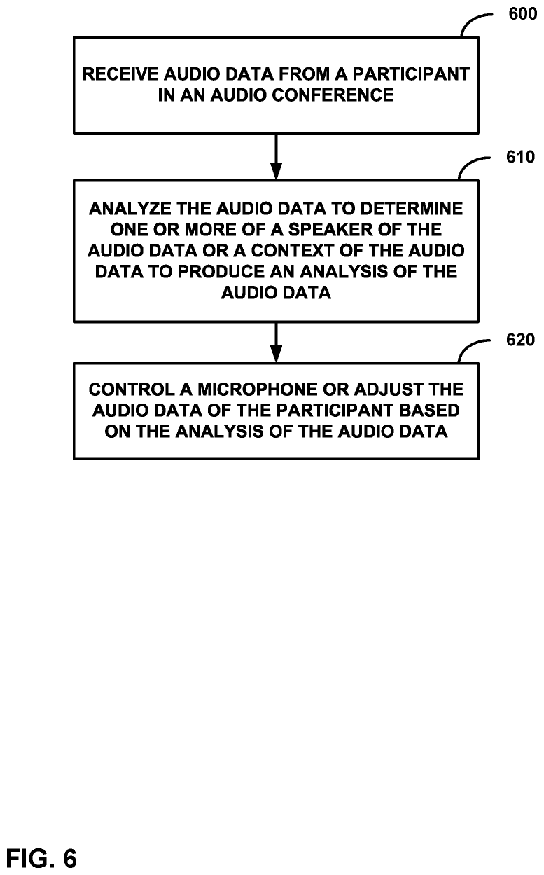

FIG. 6 is a flowchart illustrating another example technique for muting and unmuting a microphone. The techniques of FIG. 6 may be performed by one or more structural components of device 12, including A/V processing unit 18. In some examples, the techniques of FIG. 6 may be performed by a remote device (e.g., a cloud server) located separately from the device having the microphone.

In one example of the disclosure, A/V processing unit 18 may be configured to receive audio data from a participant in the audio conference (600). A/V processing unit 18 may be further configured to analyze the audio data to determine one or more of a speaker of the audio data or a context of the audio data to produce an analysis of the audio data (610), and control a microphone or adjust the audio data of the participant based on the analysis of the audio data (620).

In one example of the disclosure, to analyze the audio data to determine the one or more of the speaker of the audio data or the context of the audio data, A/V processing unit 18 is configured to analyze the audio data using one or more artificial intelligence techniques or machine learning techniques. In one example, the one or more artificial intelligence or machine learning techniques include a neural network. In another example, the one or more artificial intelligence or machine learning techniques include natural language processing.

Some examples of the disclosure relate to the automatic muting of microphones or audio data. In one example, to analyze the audio data to determine the speaker of the audio data, A/V processing unit 18 is configured to classify the audio data relative to a registered version of the voice of the participant to determine a speaker classification. In one example, the registered version of the voice of the participant is used as training data for a neural network. A/V processing unit 18 may be further configured to determine if the audio data is representative of the voice of the participant based on the speaker classification.

In one example, to control the microphone or adjust the audio data of the participant based on the analysis of the audio data, A/V processing unit 18 is configured to mute the microphone or mute the audio data of the participant based on the determination that the audio data is not representative of the voice of the participant. In another example, A/V processing unit 18 is configured to not mute the microphone or not mute the audio data of the participant based on the determination that the audio data is representative of the voice of the participant.

In another example, to analyze the audio data to determine the context of the audio data, A/V processing unit 18 is configured to classify content of the audio data relative to training data to determine a context classification, and determine if the audio data is representative of a context of the audio conference based on the context classification. In one example, to control the microphone or adjust the audio data of the participant based on the analysis of the audio data, A/V processing unit 18 is configured to mute the microphone or mute the audio data of the participant based on the determination that the audio data is not representative of the context of the audio conference. In another example, A/V processing unit 18 is configured to not mute the microphone or not mute the audio data of the participant based on the determination that the audio data is representative of the context of the audio conference.

A/V processing unit 18 may be configured to train a neural network using the registered voice of the participant and/or training data that includes grammar indicative of the context of the audio conference. A/V processing unit 18 may then classify the audio data for speaker identification and/or context using the trained neural network.

Some examples of the disclosure relate to the automatic unmuting of microphones or audio data. In one example, to analyze the audio data to determine one or more of the speaker of the audio data or the context of the audio data, A/V processing unit 18 is configured to classify the audio data relative to a registered version of the voice of the participant to determine a speaker classification, and determine if the audio data is representative of the voice of the participant based on the speaker classification. In other examples, A/V processing unit 18 may be configured to classify content of the audio data relative to training data to determine a context classification, and determine if the audio data is representative of a context of the audio conference based on the context classification. In other examples, A/V processing unit 18 may be configured to determine both a speaker classification and a content classification.

A/V processing unit 18 may be further configured to determine that the audio data of the participant is muted, and unmute the audio data of the participant based on the determination that the audio data is representative of the voice of the participant and/or based on the determination that the audio data is representative of the context of the audio conference.

Other aspects of the devices, methods, and techniques of this disclosure are described below.

Aspect 1—An apparatus configured to control an audio conference, the apparatus comprising: a memory configured to receive audio data from a participant in the audio conference; and one or more processor in communication with the memory, the one or more processors configured to: analyze the audio data to determine one or more of a speaker of the audio data or a context of the audio data to produce an analysis of the audio data; and control a microphone or adjust the audio data of the participant based on the analysis of the audio data.

Aspect 2—The apparatus of Aspect 1, wherein to analyze the audio data to determine the one or more of the speaker of the audio data or the context of the audio data, the one or more processors are configured to: analyze the audio data using one or more artificial intelligence techniques or machine learning techniques to produce the analysis of the audio data.

Aspect 3—The apparatus of Aspect 2, wherein the one or more artificial intelligence or machine learning techniques include a neural network.

Aspect 4—The apparatus of Aspect 2, wherein the one or more artificial intelligence or machine learning techniques include natural language processing.

Aspect 5—The apparatus of any of Aspects 1-4, wherein to analyze the audio data to determine the speaker of the audio data, the one or more processors are further configured to: classify the audio data relative to a registered version of a voice of the participant to determine a speaker classification; and determine if the audio data is representative of the voice of the participant based on the speaker classification.

Aspect 6—The apparatus of Aspect 5, wherein to control the microphone or adjust the audio data of the participant based on the analysis of the audio data, the one or more processors are configured to: mute the microphone or mute the audio data of the participant based on the determination that the audio data is not representative of the voice of the participant.

Aspect 7—The apparatus of Aspect 5, wherein to control the microphone or adjust the audio data of the participant based on the analysis of the audio data, the one or more processors are configured to: not mute the microphone or not mute the audio data of the participant based on the determination that the audio data is representative of the voice of the participant.

Aspect 8—The apparatus of Aspect 5, wherein the one or more processors are configured to: train a neural network using the registered version of the voice of the participant, and wherein to classify the audio data, the one or more processors are configured to classify the audio data using the neural network.

Aspect 9—The apparatus of any of Aspects 1-8, wherein to analyze the audio data to determine the context of the audio data, the one or more processors are further configured to: classify content of the audio data relative to training data to determine a context classification; and determine if the audio data is representative of a context of the audio conference based on the context classification.

Aspect 10—The apparatus of Aspect 9, wherein to control the microphone or adjust the audio data of the participant based on the analysis of the audio data, the one or more processors are configured to: mute the microphone or mute the audio data of the participant based on the determination that the audio data is not representative of the context of the audio conference.

Aspect 11—The apparatus of Aspect 9, wherein to control the microphone or adjust the audio data of the participant based on the analysis of the audio data, the one or more processors are configured to: not mute the microphone or not mute the audio data of the participant based on the determination that the audio data is representative of the context of the audio conference.

Aspect 12—The apparatus of Aspect 9, wherein the one or more processors are configured to: train a neural network using the training data, wherein the training data includes grammar indicative of the context of the audio conference, and wherein to classify the audio data, the one or more processors are configured to classify the audio data using the neural network.

Aspect 13—The apparatus of any of Aspects 1-12, wherein to analyze the audio data to determine one or more of the speaker of the audio data or the context of the audio data, the one or more processors are further configured to: classify the audio data relative to a registered version of a voice of the participant to determine a speaker classification; determine if the audio data is representative of the voice of the participant based on the speaker classification; classify content of the audio data relative to training data to determine a context classification; and determine if the audio data is representative of a context of the audio conference based on the context classification.

Aspect 14—The apparatus of Aspect 13, wherein to control the microphone or adjust the audio data of the participant based on the analysis of the audio data, the one or more processors are configured to: determine that the audio data of the participant is muted; and unmute the audio data of the participant based on the determination that the audio data is representative of the voice of the participant and based on the determination that the audio data is representative of the context of the audio conference.

Aspect 15—A method for controlling an audio conference, the method comprising: receiving audio data from a participant in the audio conference; analyzing the audio data to determine one or more of a speaker of the audio data or a context of the audio data to produce an analysis of the audio data; and controlling a microphone or adjusting the audio data of the participant based on the analysis of the audio data.

Aspect 16—The method of Aspect 15, wherein analyzing the audio data to determine the one or more of the speaker of the audio data or the context of the audio data comprises: analyzing the audio data using one or more artificial intelligence techniques or machine learning techniques to produce the analysis of the audio data.

Aspect 17—The method of Aspect 16, wherein the one or more artificial intelligence or machine learning techniques include a neural network.

Aspect 18—The method of Aspect 16, wherein the one or more artificial intelligence or machine learning techniques include natural language processing.

Aspect 19—The method of any of Aspects 15-18, wherein analyzing the audio data to determine the speaker of the audio data comprises: classifying the audio data relative to a registered version of a voice of the participant to determine a speaker classification; and determining if the audio data is representative of the voice of the participant based on the speaker classification.

Aspect 20—The method of Aspect 19, wherein controlling the microphone or adjusting the audio data of the participant based on the analysis of the audio data comprises: muting the microphone or muting the audio data of the participant based on the determination that the audio data is not representative of the voice of the participant.

Aspect 21—The method of Aspect 19, wherein controlling the microphone or adjusting the audio data of the participant based on the analysis of the audio data comprises: not muting the microphone or not muting the audio data of the participant based on the determination that the audio data is representative of the voice of the participant.

Aspect 22—The method of Aspect 19, further comprising: training a neural network using the registered version of the voice of the participant, and wherein classifying the audio data comprises classifying the audio data using the neural network.

Aspect 23—The method of any of Aspects 15-22, wherein analyzing the audio data to determine the context of the audio data comprises: classifying content of the audio data relative to training data to determine a context classification; and determining if the audio data is representative of a context of the audio conference based on the context classification.

Aspect 24—The method of Aspect 23, wherein controlling the microphone or adjusting the audio data of the participant based on the analysis of the audio data comprises: muting the microphone or muting the audio data of the participant based on the determination that the audio data is not representative of the context of the audio conference.

Aspect 25—The method of Aspect 23, wherein controlling the microphone or adjusting the audio data of the participant based on the analysis of the audio data comprises: not muting the microphone or not muting the audio data of the participant based on the determination that the audio data is representative of the context of the audio conference.

Aspect 26—The method of Aspect 23, further comprising: training a neural network using the training data, wherein the training data includes grammar indicative of the context of the audio conference, and wherein classifying the audio data comprises classifying the audio data using the neural network.

Aspect 27—The method of any of Aspects 15-26, wherein analyzing the audio data to determine one or more of the speaker of the audio data or the context of the audio data comprises: classifying the audio data relative to a registered version of a voice of the participant to determine a speaker classification; determining if the audio data is representative of the voice of the participant based on the speaker classification; classifying content of the audio data relative to training data to determine a context classification; and determining if the audio data is representative of a context of the audio conference based on the context classification.

Aspect 28—The method of Aspect 27, wherein controlling the microphone or adjusting the audio data of the participant based on the analysis of the audio data comprises: determining that the audio data of the participant is muted; and unmuting the audio data of the participant based on the determination that the audio data is representative of the voice of the participant and based on the determination that the audio data is representative of the context of the audio conference.

Aspect 29—A non-transitory computer-readable storage medium storing instructions that, when executed, cause one or more processors to: receive audio data from a participant in an audio conference; analyze the audio data to determine one or more of a speaker of the audio data or a context of the audio data to produce an analysis of the audio data; and control a microphone or adjust the audio data of the participant based on the analysis of the audio data.

Aspect 30—An apparatus configured to control an audio conference, the apparatus comprising: means for receiving audio data from a participant in the audio conference; means for analyzing the audio data to determine one or more of a speaker of the audio data or a context of the audio data to produce an analysis of the audio data; and means for controlling a microphone or adjusting the audio data of the participant based on the analysis of the audio data.

In one or more examples, the functions and techniques described herein may be implemented in hardware, software, firmware, or any combination thereof. If implemented in software, the functions and techniques may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software units or modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to control an audio conference, the apparatus comprising:
a memory configured to receive audio data from a participant in the audio conference; and
one or more processors in communication with the memory, the one or more processors configured to:
analyze the audio data to determine one or more of a speaker of the audio data or a context of the audio data to produce an analysis of the audio data; and
control a microphone or adjust the audio data of the participant based on the analysis of the audio data.

2. The apparatus of claim 1, wherein to analyze the audio data to determine the one or more of the speaker of the audio data or the context of the audio data, the one or more processors are configured to:
analyze the audio data using one or more artificial intelligence techniques to produce the analysis of the audio data.

3. The apparatus of claim 2, wherein the one or more artificial intelligence techniques include a neural network.

4. The apparatus of claim 2, wherein the one or more artificial intelligence techniques include natural language processing.

5. The apparatus of claim 1, wherein to analyze the audio data to determine the speaker of the audio data, the one or more processors are further configured to:
classify the audio data relative to a registered version of a voice of the participant to determine a speaker classification; and
determine if the audio data is representative of the voice of the participant based on the speaker classification.

6. The apparatus of claim 5, wherein to control the microphone or adjust the audio data of the participant based on the analysis of the audio data, the one or more processors are configured to:
mute the microphone or mute the audio data of the participant based on the determination that the audio data is not representative of the voice of the participant.

7. The apparatus of claim 5, wherein to control the microphone or adjust the audio data of the participant based on the analysis of the audio data, the one or more processors are configured to:
not mute the microphone or not mute the audio data of the participant based on the determination that the audio data is representative of the voice of the participant.

8. The apparatus of claim 5, wherein the one or more processors are configured to:
train a neural network using the registered version of the voice of the participant, and
wherein to classify the audio data, the one or more processors are configured to classify the audio data using the neural network.

9. The apparatus of claim 1, wherein to analyze the audio data to determine the context of the audio data, the one or more processors are further configured to:
classify content of the audio data relative to training data to determine a context classification; and
determine if the audio data is representative of a context of the audio conference based on the context classification.

10. The apparatus of claim 9, wherein to control the microphone or adjust the audio data of the participant based on the analysis of the audio data, the one or more processors are configured to:
mute the microphone or mute the audio data of the participant based on the determination that the audio data is not representative of the context of the audio conference.

11. The apparatus of claim 9, wherein to control the microphone or adjust the audio data of the participant based on the analysis of the audio data, the one or more processors are configured to:
not mute the microphone or not mute the audio data of the participant based on the determination that the audio data is representative of the context of the audio conference.

12. The apparatus of claim 9, wherein the one or more processors are configured to:
train a neural network using the training data, wherein the training data includes grammar indicative of the context of the audio conference, and
wherein to classify the audio data, the one or more processors are configured to classify the audio data using the neural network.

13. The apparatus of claim 1, wherein to analyze the audio data to determine one or more of the speaker of the audio data or the context of the audio data, the one or more processors are further configured to:
classify the audio data relative to a registered version of a voice of the participant to determine a speaker classification;
determine if the audio data is representative of the voice of the participant based on the speaker classification;
classify content of the audio data relative to training data to determine a context classification; and
determine if the audio data is representative of a context of the audio conference based on the context classification.

14. The apparatus of claim 13, wherein to control the microphone or adjust the audio data of the participant based on the analysis of the audio data, the one or more processors are configured to:
determine that the audio data of the participant is muted; and
unmute the audio data of the participant based on the determination that the audio data is representative of the voice of the participant and based on the determination that the audio data is representative of the context of the audio conference.

15. A method for controlling an audio conference, the method comprising:
receiving audio data from a participant in the audio conference;
analyzing the audio data to determine one or more of a speaker of the audio data or a context of the audio data to produce an analysis of the audio data; and
controlling a microphone or adjusting the audio data of the participant based on the analysis of the audio data.

16. The method of claim 15, wherein analyzing the audio data to determine the one or more of the speaker of the audio data or the context of the audio data comprises:
analyzing the audio data using one or more artificial intelligence techniques or machine learning techniques to produce the analysis of the audio data.

17. The method of claim 16, wherein the one or more artificial intelligence or machine learning techniques include a neural network.

18. The method of claim 16, wherein the one or more artificial intelligence or machine learning techniques include natural language processing.

19. The method of claim 15, wherein analyzing the audio data to determine the speaker of the audio data comprises:
classifying the audio data relative to a registered version of a voice of the participant to determine a speaker classification; and
determining if the audio data is representative of the voice of the participant based on the speaker classification.

20. The method of claim 19, wherein controlling the microphone or adjusting the audio data of the participant based on the analysis of the audio data comprises:
muting the microphone or muting the audio data of the participant based on the determination that the audio data is not representative of the voice of the participant.

21. The method of claim 19, wherein controlling the microphone or adjusting the audio data of the participant based on the analysis of the audio data comprises:
not muting the microphone or not muting the audio data of the participant based on the determination that the audio data is representative of the voice of the participant.

22. The method of claim 19, further comprising:
training a neural network using the registered version of the voice of the participant, and
wherein classifying the audio data comprises classifying the audio data using the neural network.

23. The method of claim 15, wherein analyzing the audio data to determine the context of the audio data comprises:
classifying content of the audio data relative to training data to determine a context classification; and
determining if the audio data is representative of a context of the audio conference based on the context classification.

24. The method of claim 23, wherein controlling the microphone or adjusting the audio data of the participant based on the analysis of the audio data comprises:
muting the microphone or muting the audio data of the participant based on the determination that the audio data is not representative of the context of the audio conference.

25. The method of claim 23, wherein controlling the microphone or adjusting the audio data of the participant based on the analysis of the audio data comprises:
not muting the microphone or not muting the audio data of the participant based on the determination that the audio data is representative of the context of the audio conference.

26. The method of claim 23, further comprising:
training a neural network using the training data, wherein the training data includes grammar indicative of the context of the audio conference, and
wherein classifying the audio data comprises classifying the audio data using the neural network.

27. The method of claim 15, wherein analyzing the audio data to determine one or more of the speaker of the audio data or the context of the audio data comprises:
classifying the audio data relative to a registered version of a voice of the participant to determine a speaker classification;
determining if the audio data is representative of the voice of the participant based on the speaker classification;
classifying content of the audio data relative to training data to determine a context classification; and
determining if the audio data is representative of a context of the audio conference based on the context classification.

28. The method of claim 27, wherein controlling the microphone or adjusting the audio data of the participant based on the analysis of the audio data comprises:
determining that the audio data of the participant is muted; and
unmuting the audio data of the participant based on the determination that the audio data is representative of the voice of the participant and based on the determination that the audio data is representative of the context of the audio conference.

29. A non-transitory computer-readable storage medium storing instructions that, when executed, cause one or more processors to:
receive audio data from a participant in an audio conference;
analyze the audio data to determine one or more of a speaker of the audio data or a context of the audio data to produce an analysis of the audio data; and
control a microphone or adjust the audio data of the participant based on the analysis of the audio data.

30. An apparatus configured to control an audio conference, the apparatus comprising:
means for receiving audio data from a participant in the audio conference;
means for analyzing the audio data to determine one or more of a speaker of the audio data or a context of the audio data to produce an analysis of the audio data; and
means for controlling a microphone or adjusting the audio data of the participant based on the analysis of the audio data.
